(19) United States
(12) Patent Application Publication
(10) Pub. No.: US 2021/0104005 A1
(43) Pub. Date: Apr. 8, 2021

(54) Method Process Patent For Picking Up Samples For Home Renovation Or Any Other Type Of US Consumer Product

(71) Applicant: Michael Drew Cassidy, Decatur, GE (US)

(72) Inventor: Michael Drew Cassidy, Decatur, GE (US)

(21) Appl. No.: 16/594,916

(22) Filed: Oct. 7, 2019

(51) Int. Cl. G06Q 90/00

(52) U.S. Cl. CPC G06Q 90/00

(57) ABSTRACT

A method and system that is designed to provide a One-Stop shop. The system particularly focuses on construction and home renovation sample material, or any US products sold, by presenting a big sample box with multiple slots. To accommodate multiply clients at any given time. These boxes are kept at any designated vicinity and neighborhood, where a client could easily walk to collect the samples or products required. These samples or products can be seen and selected physically as compared to electronically. Moreover, the samples can be returned and exchanged as required.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention:

This invention relates to systems for engaging in commerce. More particularly, the present invention is a construction sample ordering system and method for providing customized delivery as per customer's requirements.

### Description of the Related Art:

With the growth of the Internet, businesses have begun establishing online systems for transacting business. The online market environment is growing fast but still hasn't achieved high penetration due to the slowness of options availability at online environment.

There are multiple systems that have been proposed in prior art regarding ordering system. For instance, Raw materials ordering system bearing U.S. Pat. No. 5,914,878A is issued to Kracie Home Products Ltd Kracie Holdings Ltd. The method relates to a production system for retail goods which is intended for timely collection of accurate sales information from retail outlets and flexible production of goods in accordance with the same information, and comprises a retail sales information collecting means, a, production quantity setting means for determining a production quantity according to the information so collected, a directing means for directing the preparation and production of raw materials according to the determined production quantity, and a production means for producing the determined production quantity according to a direction to produce. Also provided is a raw materials ordering system, which determines production quantities of raw materials in accordance with production plans for ensuring flexible production of the products without the disadvantage of carrying excessive inventories and for economical and efficient control and supply of raw materials. As such, the system comprises an order quantity determining means for setting or modifying daily required quantities of raw materials in response to setting or modification of daily production plans and determining order quantities according to raw material attributes, inventories, order backlogs, in-process order quantities and the required quantities of raw materials and a data input processing means for modifying the raw material inventory quantities upon receipt of raw material acceptance information. Furthermore, another type of the raw material ordering system disclosed in this application can be employed for those raw materials that require processing after placement of an order.

Another invention on Methods and apparatus for on-line ordering bearing U.S. Pat. No. 9,129,319B2 is issued to Peter A. BurtonDror Segal. The patent is about systems and methods for ordering supplies from suppliers or for other e-commerce activities are described. Standards for placing orders and registering catalog information in a database are described. Systems and methods for placing orders, preprocessing supplier information using geographic information, conducting data searches and analysis locally on user access devices, continuously updating displays of browser frames, tracking orders using accounting codes, placing graphical custom orders, submitting graphical orders to suppliers, placing group orders, reducing risks associated with delinquent accounts receivable, and combinations thereof are described.

Another Internet online order method and apparatus bearing U.S. Pat. No. 5,991,739A is issued to Comdisco Inc IPDEV Co. The patent is about a system and method for providing an online ordering machine that manages the distribution of home delivered products over a distributed computer system is herein disclosed. The distributed computer system includes a group of customers connected to client computers and at least one server computer system that executes the online ordering machine. The online ordering machine provides the customers with product information from various vendors whose delivery range is within the customer's location or with product information from vendors having take out service within a specified range from the customer's location. The vendor's and customer's location is associated with a geocode representing the latitude and longitude coordinates of the location. The search for the vendors servicing the customer's location is done using the geocodes. The online ordering machine accepts orders from the customer for a particular product from a selected vendor. The order is converted into voice instructions which are transmitted to the vendor through a telephone call. The vendor receives the telephonic order and responds to voice-prompted instructions used to confirm the order.

Another Internet shopping system utilizing set top box and voice recognition bearing U.S. Pat. No. 6,5430,52B1 is issued to Google LLC. The patent is about an Internet-based electronic shopping system hosted on a television-set-top-box combination controlled by a remote control unit. The set-top box (STB) includes a tuner, an internal or external modem and/or cable modem, configured to communicate with an Internet service provider over the appropriate transmission media. The STB also includes purpose-type application software such as voice recognition software and bar code recognition software to support an electronic shopping system. The STB further includes an external interface for connection to a multiplicity of external peripheral devices, such as an interphone, VCR, video camera, printer, and the like. The remote control unit includes a keypad, a microphone, an optional speaker, an optional digital camera, and an optional speaker. Data input to an Internet shopping Web program accessed through the STB's Web browser may thus be made through the microphone, keypad, and optionally through the digital camera. If the remote-control unit includes the digital camera, bar code information may be scanned by the remote control unit and transmitted to the STB for identifying an item to be purchased. The remote-control unit is also capable of being used as a cordless telephone or videophone, and might also function as a handset for an interphone when the appropriate communication links are connected to the STB through its external interface. When the system is used as a videophone, video graphic images of a party on the other end of the line is displayed on the TV screen via a pop-up window.

Another Method of daily parts ordering bearing US patent 2,004,0044595A1 is issued to Honda Motor Co Ltd. The patent is about a method for daily ordering of parts for one or more parts warehouses, includes, determining a specified part number and available supplier from which to place a daily parts order for the specified part number; obtaining from each warehouse, a total available inventory for the specified part number; preparing a sales forecast for the specified part number, wherein the sales forecast includes one or more months; converting the sales forecast into a running daily forecast covering a specified order point period of time beginning on a predetermined day; generating a total daily order point quantity of units for the specified part number, based on the running daily forecast; and ordering parts, corresponding to the specified part number, from a supplier, wherein the quantity of parts ordered corresponds to the difference between the total daily order point quantity and the total available inventory.

While Internet based home shopping systems allow a home shopping customer a great deal of flexibility, Internet based home shopping systems, particularly Internet based samples for home construction and renovation, suffer from various disadvantages, specifically with regard to customized requirements for individual home needs. For many decades in the United States people have had the daunting task of picking up different types of samples to view for their renovation project on the home. These samples would include paint, carpet, roofing, wood flooring, window treatments and so on.

Typically, people would either have two choices. To have a consultant or sales person come to their house to show them selected samples of the previous mentioned items. The other option is to travel to a local establishment like a Home Depot or to a local paint or flooring store. As far as paints are considered, consumers would typically purchase a small amount of paint in a sample container or “sampler” and have to go home and apply that sample paint onto a board or onto the wall. In short, the sampler industry specifically with house paint material is extremely wasteful.

There is a huge requirement or (need?) for a method and system that is specifically designed to allow all consumers to view and then purchase these various types of construction-based samples within their vicinity (close, proximity). The requirements which can vary from paint samples to carpet, roofing, wood flooring, window treatments and so on can be entertained easily.

From the prior art search it has been noted that as per Applicant's knowledge, none of these prior art methods have been found to provides customers a customized sample ordering system which allows consumers to order samples as per their requirements for their home needs.

Therefore, the current invention seeks to provide a solution for this problem by creating a localized neighborhood sample box, which when allowed, can be housed at every community in the United States, using the vehicle of nextdoor.com to communicate to individual neighbors. It would carry multiple types of samples primarily related to construction needs, but is not limited in scope. It would include ANY type of product sample imaginable. These samples can be ordered, exchanged, purchased or returned as per consumer requirements. This system could also store, in limited cases, gift items, special packages from shippers like Amazon, Fedex or the USPS. In cases where a locked box is needed.

Typically, most US households do not possess a locking mechanism for their current postal box.

Thus, there is a need in the prior art in which the aforementioned inconveniences, difficulties, and grooming problems are, for all practical purposes, eliminated. Thus, the present invention provides such a method and the overall combination of these features is nowhere disclosed in the prior art cited above which appears to be representative of the general art in this area although it is not intended to be an all-inclusive listing of pertinent prior art patents.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

Embodiments of the invention relates to the presentation of multiple type of samples related to construction of homes or buildings or other items that can be useful.

A prime objective of the present invention is to provide an improved form of ordering samples for consumers at the closest proximity to their residence.

It is moreover the objective of the invention to provide customers a sample box out in their neighborhood or in another neighborhood, to be in close proximity to their residence. The sample box that would hold the following items, including but not limited to large painted samples on plastic boards, carpet samples, flooring samples, home improvement samples, Shingle samples for roofing and many more. To include ANY type of sample or physical product to be sold online and picked up at the sample box.

Another very important object of the instant invention is the provision of an ease of use and utility of time saving by allowing samples in a buyer's close vicinity. Color sample boards could be produced and then placed in the sample box in as little as 30 minutes. Creating a sort of Paint On Demand service. If the color boards have already been made, this pickup time would be even less. 10 minutes. This is because the vendor works out of their home to continually provide these samples to the client. In essence, the vendor wants to have their clients for repeat business. To supply them any sample product desired for years to come.

Yet another significant object of the invention is to provide users with easy options as per individual requests at their door step without any hassle.

Another object of the invention is to provide the option of exchanging or returning samples when required.

Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 is a complete view of sample box assembly with multiple compartments arranged horizontally consistent with the exemplary embodiments of the present invention.

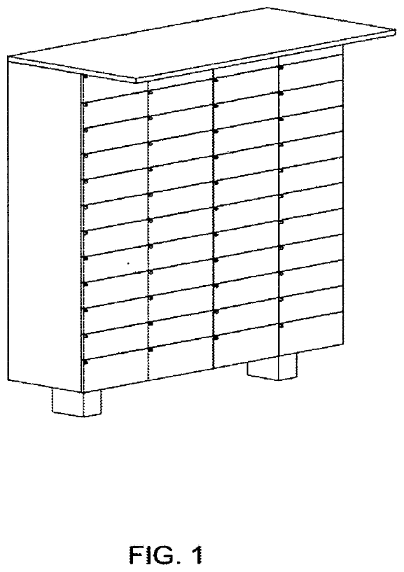

FIG. 2 is another view of sample box assembly with multiple compartments arranged horizontally consistent with the exemplary embodiments of the present invention.

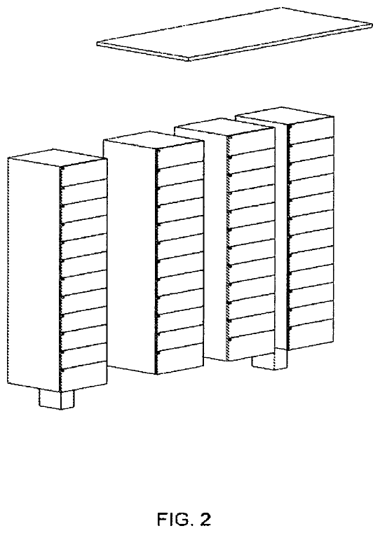

FIG. 3 is a 3D view of sample box showing multiple vertically arranged compartments to store samples consistent with exemplary embodiments of the invention.

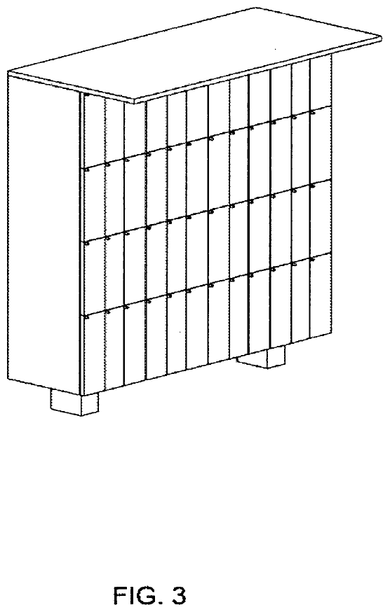

FIG. 4 is a complete view of sample box showing multiple vertically arranged compartments in disassembled form consistent with exemplary embodiments of the invention.

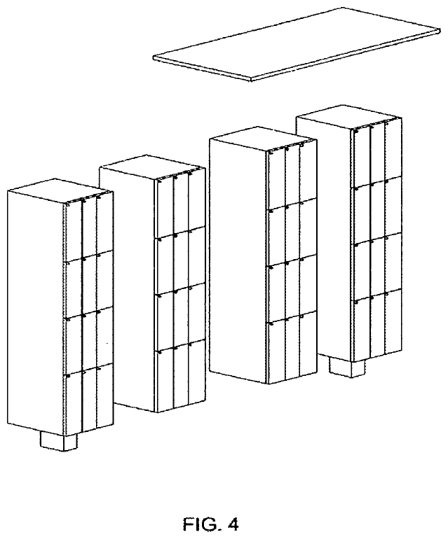

FIG. 5 displays a flow chart depicting a method for the pickup and delivery and return of products in accordance with embodiments.

### DETAILED DESCRIPTION

Before explaining the invention in detail, it is to be understood that the invention is not limited in its application to the detail of application illustrated in the drawings since the invention is capable of other embodiments and of being practiced or carried out in various ways. It is also to be understood that the phraseology or terminology employed is for the purpose of description only and not of limitation.

The current invention in its preferred embodiment discloses a method and system that is designed to allow all consumers to pick up and return samples or consumer products for home renovation and for any other similar purpose.

The system as per its preferred embodiments presents a vendor or representative living in a particular neighborhood, the means of advertising in this neighborhood would primarily be on nextdoor.com or possible a local paper or newsletter. The advertising will mention the neighborhood vendor. Which can expand through word of mouth, digital or social media and thus covering a larger area with an extremely low cost of advertisement to the individual vendor. Any transactions would initially occur online.

The customers as per additional embodiments would be allowed to walk or drive to their neighborhood sample box, usually in a proximity of less than 5 square miles. This would be a convenient method to pick up their order from the sample box, that would hold the following samples including but not limited to large painted samples on plastic boards, carpet samples, flooring samples, home improvement samples, Shingle samples for roofing and many more. A client could, at their chosen time, come by and pick up any type of sample or product that they had originally ordered online. The Vendor, at his/her residence would stipulate the hours of operation. (6 am to 11 pm). The vendor in essence would have this territory (up to 5 square miles) and would be the continued representative for any and all kinds of sample materials and/or products. In case the client is out of town or away the box could be used to store other valuable items locally. This box enables up to 50 clients (or more) to have their items stored. Multiple clients could share one slot in this sample box, enabling hundreds of clients to lease the box throughout any given week. There would be a lock on each “client slot”(inside the giant box) if needed depending on the type of box built. Some box slots would not require a lock. The box would-be built-in sections to be 2-feet-long and 30 inch deep. Any size can be created for the box with the initial 2 feet section combined with another 2-foot box section, you would be creating a 4-foot box, then adding another 2 foot section a 6 foot box, adding another 2 foot section would create an 8 foot sectional box. The sample box would contain any type of lighting and added security cameras when needed.

The system as per its preferred embodiments aim to present method and process for the pickup and delivery and return of products of a centralized neighborhood hub. The system basically aims at using primarily nextdoor.com as an advertising base. It allows companies like Amazon the United States Post Office to leave packages in a secured locked box location which allows neighbors within this area to leave packages in a secure lock box location.

One of the unique features as per additional embodiments is that with the paint samples, they will actually be made with real paint then be scanned and loaded onto the computer. Currently the paint industry claims to have up to 3000 paint colors. Most of these are pc generated color or a printed color on an industry standard chip. This particular service of paint board selection will start with around 200 colors which will be viewed on a computer screen initially. The client will have option of choose any type of sample and then place an order.

The order will be for how many samples that they are going to acquire and length of time to lease their “slot” from the large box outside at the street (vendors home) The box would have many slots capable of holding up to 50 clients and beyond. These would be numbered slots, with customer names written on their personalized bags they would be using to hold their samples. This would be a very large box encompassing around 8 feet long 6 ft high and at least 24 in deep.

A client as per additional embodiments would have use of their space in this box, along with other clients, potentially sharing this space which would be similar to a postal box. This request would be made by the client, which could be up to one month of duration if needed. If for instance a customer choose paint samples, large boards that are up to 32 in by 20 and made paint and plastic board and wanted to get 10 samples. They order, then like five of them and wanted to return the other five and get five more. At no extra cost.

The proposed method also presents a cost-effective way for purchasing/leasing samples or any other type of product. For instance, if somebody wants to take a particular sample home, they would initially leave a deposit and then after confirmation of color choice, bring the sample board back. One of the novel features of this invention is that people will acquire the samples, borrow them and then bring them back, receive a small 8 inch painted checking sample, to then order from the paint store. That store in essence would have the same 8 inch sample made from the same original paint. This paint store could delivery their paint when needed. They could also give this smaller sample to their painter, to again take to the paint store to purchase the needed house paint. They wouldn't have to drive to the store, park their car go inside and waste their gas and time. Typically consumers would be within one, two, three or possibly up to five mile radius from one of these vendors boxes out in front of their home.

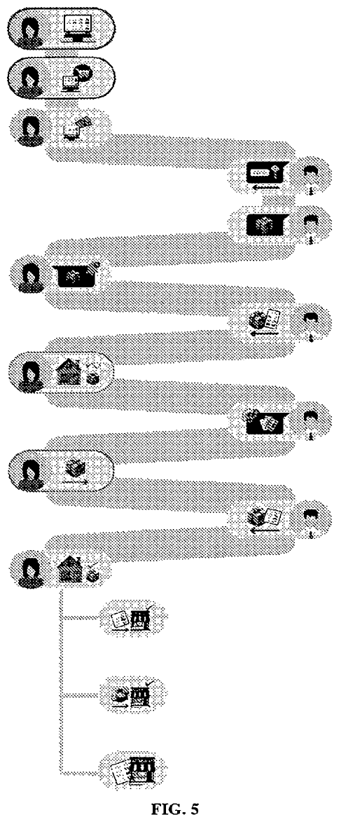

FIG. 5 displays a flow chart depicting a method for the pickup and delivery and return of products in accordance with embodiments. In embodiments, the method may be referred to with the letters “VOCR”, which, in embodiments, may be representative of steps in the method wherein V=VIEW, O=ORDER, C=CONFIRM, and R=RETURN. Information found in the following paragraph may be included in the method:

Customer views color samples on pc.

Customer orders selected color samples.

Customer pays for a particular level of service.

Vendor/owner of “sample box” sends customer lock code/or box number.

Vendor gets the customer order ready. Vendor notifies customer their order is ready.

Vendor puts selected customer order in box with customer name on bag holding the color boards.

Customers picks up selected color board sample (15×20 inch) or (32×20 inch) from box.

Customers confirms/reviews color boards at home residence.

Customer emails to vendor the color choices.

Customer returns selected color boards to box.

Customer picks up/receives at time of return of color selections,

Smaller sample (8×8) inch of their color choice.

(1) options: customer takes sample (8×8 inch) to the selected paint store for confirmation.

(2) option: customer gives (8×8 inch sample to their house painter for confirmation to order paint and check at paint store.

(3) option: 8-inch sample cards can be left at paint store or returned to sample box.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A method for picking up construction related or any other type of product samples used by US consumers in their daily lives. Including: A sample box with measurements to be
Eight feet long, 6 feet height and 24 feet deep, made from any type of material conceived (wood, plastic or metal). This sample box is formed from an integral blank of fibrous sheet material comprising a bottom panel, upright side walls delimiting said bottom panel, and a top panel disposed in spaced registered relation with respect to said bottom panel and having the periphery consisting of multiple slots. These slots are registered to receive multiple type of samples related to carpet samples, flooring samples, home improvement samples, Shingle samples for roofing, or any type of sample or product to be conceived. These slots are registered to individual, or multiple clients. The sample box containing the appropriate type of lighting, to include battery operated or traditional electrical lighting. To allow customers to come early in the morning or late at night and be able to view their slot in the Sample Box. Security cameras could be added for extra added protection. The location of the sample box would be as following. At the street level, any location in the vendors driveway or any location next to the house. Either attached or a stand-alone version, next to the primary housing structure of a particular vendors location or residence.

2. The system includes a centralized neighborhood box containing many multiple samples or any type of product. To service clients in a close proximity of their location. Creating a local atmosphere and personalized feel to this service.
